(19) United States
(12) Patent Application Publication
(10) Pub. No.: US 2002/0180789 A1
(43) Pub. Date: Dec. 5, 2002

(54) Framework for developing web-based and email-based collaborative programs

(76) Inventors: Gregory Guttmann, San Francisco, CA (US); Giles Goodwin, San Francisco, CA (US); Robert Abrazado, (US); Nathan Sequeria, San Francisco, CA (US); Grant Lee, Oakland, CA (US); Isaac Walker, San Francisco, CA (US); Conrad Pino, San Leandro, CA (US); Daniel Sudol, San Rafael, CA (US); Aaron Sperling, San Francisco, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/870,993

(22) Filed: Jun. 1, 2001

(51) Int. Cl. G09G 5/00

(52) U.S. Cl. 345/760; 345/763; 345/967

(57) ABSTRACT

A method and a system for developing/customizing web-based collaborative applications are provided. The system is a scalable, secure, enterprise class software platform for web and email-based collaborative application. The system provides a platform to develop and customize as well as deploy these applications. The application engine of the system can leverage libraries of pre-existing applications or rapidly build entirely new that allow focusing on the solution to customer needs. A web-based application built employing the system's application engine is a composite of definitions of application components. Browser-based wizards are provided by the application engine of the system to define application component types. The application engine of the system also provides for combining/tying these application component types together.

### BACKGROUND OF THE INVENTION

1. Field of the Invention

The present invention relates to systems and methods for developing and deploying computer applications and, more particularly, to systems and methods for developing and deploying computer web-based collaborative applications employing visual component objects to tie together pre-existing routines for implementing functionality.

2. Description of Prior Art

Computer application programs, including web-based and conventional programs, are developed by programmers who write program code employing computer programming statements, according to a computer programming language, to generate source code. The programming statements of the source code define the behavior and properties that the computer application program will implement to perform operations on data to achieve a desire result. Typically, the generation of an application, much less an application suite, is a tremendous undertaking. In general, the programmers must have a requite level of knowledge in the computer program language used to develop the computer application program. In addition, changes or updates to the computer application program often require that the programmer re-writing substantial portions of the source code. This is compounded when the programmer is not the original programmer and does not have access to the original programmer to obtain comments and instructions. As a result, substantial resources and time may be consumed when developing and customizing a computer application program.

To alleviate the drawbacks associated with traditional application programming, visual programming has been developed. However, visual program requires some programming functionality. In addition, the visual programs generated are often not scalable. Moreover, they are not directed toward web-based collaborative applications.

There is a need for a system for developing/customizing web-based collaborative applications employing visual component objects to tie together pre-existing routines for implementing functionality. There is also a need for a system to rapidly develop hosted business applications without knowledge of programming or Hypertext Markup Language (hereinafter “HTML”). There is also a need for a system that can leverage libraries of pre-existing applications. There is also a need for the system to provide dynamic visual representations of applications whose definition have been customized. There is also a nee for a system that can manage structure information stored in a database.

### SUMMARY OF THE INVENTION

According to embodiments of the present invention, a method and a system for developing/customizing web-based collaborative applications are provided. The system is a scalable, secure, enterprise class software platform for web and email-based collaborative application. The system provides a platform to develop and customize as well as deploy these applications. The application engine of the system can leverage libraries of pre-existing applications or rapidly build entirely new that allow focusing on the solution to customer needs. A web-based application built employing the system's application engine is a composite of definitions of application components. Browser-based wizards are provided by the application engine of the system to define application component types. The application engine of the system also provides for combining/tying these application component types together.

According to an embodiment of the present invention, a system for developing/customizing web-based collaborative applications employing visual-based programming, includes a user system operable to display a set of browser-based component wizards to develop application component types for a web-based collaborative application. A network couples to the user system and a set of processing components. The network is operable to communicate data between the user system and the set of processing components. Each processing component in the set of processing component implement functionality associated with a definition for each of the application component types. The functionality exists prior to customization of the definition for each of the application component types. The set of browser-based wizards includes a combination of a form wizard, a business rule wizard, a report wizard, a search wizard, a calendar wizard and an email wizard.

In an embodiment of the present invention, each browser-based wizard of the system is operable to customize a definition for a corresponding application component type and has a set of sub-component types. The set of sub-components types in a browser-based wizard is configured to dynamically perform the customization of the definition for the corresponding application component type. Some of the sub-component types in the set of sub-component types in the browser-based wizard are operable to dynamically generate a default visual representation of the customization of the definition in a display area of the browser-based wizard. The generation of the visual representation associates a default property definition to a properties-based portion of the definition for the corresponding application component type.

In an embodiment of the present invention, at least one of the sub-components types in the set of sub-component types in the browser-based wizard is operable to dynamically modify a properties-based portion of the definition with a customized property definition for the corresponding application component type. The customized property definition for the corresponding application component type is dynamically applied by providing visual representations in a display area of the browser-based wizard according to the customized property definition. A physical property of the corresponding application component type modified by the customized property definition includes one of orientation, position, labeling, and design.

In an embodiment of the present invention, at least one of the sub-components types in the set of sub-component types in the browser-based wizard is operable to dynamically modify a behavior-based portion of the definition with a customized behavior definition for the corresponding application component type. The customized behavior definition for the corresponding application component type is dynamically applied in accordance with the customized behavior definition to visual representations provided in a display area of the browser-based wizard. A behavioral property of the corresponding application component type modified by the customized behavior definition includes one of data input type, data input length, data requirements, data modification terms and data retrieval terms.

In an embodiment of the present invention, at least some of the sub-component types in the set of sub-component types in the browser-based wizard are operable to specify the finality of the customization of the definition for the corresponding application component. The finality specifiable includes any combination of discard customizations, implement customizations and delay customizations.

### BRIEF DESCRIPTION OF THE DRAWINGS

The above described features and advantages of the present invention will be more fully appreciated with reference to the detailed description and appended figures in which:

FIG. 1 depicts a functional block diagram of a system in which the present invention can find application;

FIG. 2 depicts a functional block diagram of a user system depicted in FIG. 1;

FIG. 3 depicts a functional block diagram of a system depicted in FIG. 1;

FIG. 4 depicts a functional block diagram of a system depicted in FIG. 1;

FIG. 5 depicts a method of according to embodiments of the present invention; and

FIGS. 6A-6C depict illustrations of browser-based wizards according to embodiments of the present invention; and

FIG. 7 depicts a database schema according to embodiments of the present invention.

### DETAILED DESCRIPTION OF THE INVENTION

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

According to embodiments of the present invention, a method and a system for developing/customizing web-based collaborative applications are provided. The system is a scalable, secure, enterprise class software platform for web and email-based collaborative application. The system provides a platform to develop and customize as well as deploy these applications. The application engine of the system can leverage libraries of pre-existing applications or rapidly build entirely new that allow focusing on the solution to customer needs. A web-based application built employing the system's application engine is a composite of definitions of application components. Browser based wizards are provided by the application engine of the system to define application component types. The application engine of the system also provides for combining/tying these application component types together.

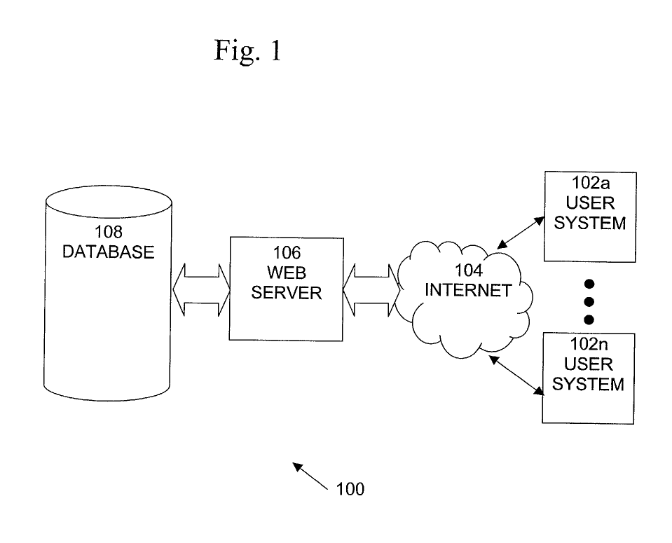

FIG. 1 depicts a functional block diagram of a system in which the present invention can find application. In the embodiment of FIG. 1, system 100 may be implemented to develop/customize web-based collaborative applications employing visual-based programming. System 100 includes user systems 102 connected to a system 106 employing network 104. System 100 may transmit using network 104, any combination of voice, video and/or data between devices. User systems 102 may be any apparatus from which, and to which, any combination of voice video and/or data may be transmitted over a network 104, such as the Internet or an extranet. User systems 102 can include computers, web access devices, workstations, telecommunication devices, and the like. Systems 102 may be used to access system 106 and perform web-based collaborative application development and customization.

System 106 is couple to system 108 and network 104. System 106 can be any computer that stores processing components for access by users and can access structure information of users of network 104 and that uses libraries, such as Java libraries. In the preferred embodiment of the present invention, system 106 supports Java Server Pages (JSP). System 106 may perform the functions of developing/customizing web-based collaborative applications. The system 106 provides a scalable, secure, enterprise class software platform for web and email-based collaborative application. An individual or a number of individuals, who are responsible for hosting business applications, may leverage existing libraries of pre-existing applications facilitate the development of entirely new applications in a visual environment.

The system 108 may be any computer that stores definitions of application component types as well as structure information managed by applications customized, developed and shared by users of network 104. The system 108 may be composed of multiple separate tables, such as 100, and separated into categories of tables, such as three. An individual or individuals responsible for hosting business applications as well as an individual or individuals that participate in accessing system 106 to perform webbased collaborative application development and customization may use system 108.

User systems 102 and system 106 may connect to one another by means of a suitable communications network 104. User system 102 may be a local area network, a wide area network, the Internet, an extranet, a wireless network, or the like. The network 104 may transfer information between user system 102 and system 106. The information transferred may include any combination of voice, video and/or data. Network 104 can be implemented as a wireless network or a wired network. In addition, database may directly transfer information to system 106 in response to a request for information as well as transfer information to user system 102 in response to a request made to system 106 by user system 102.

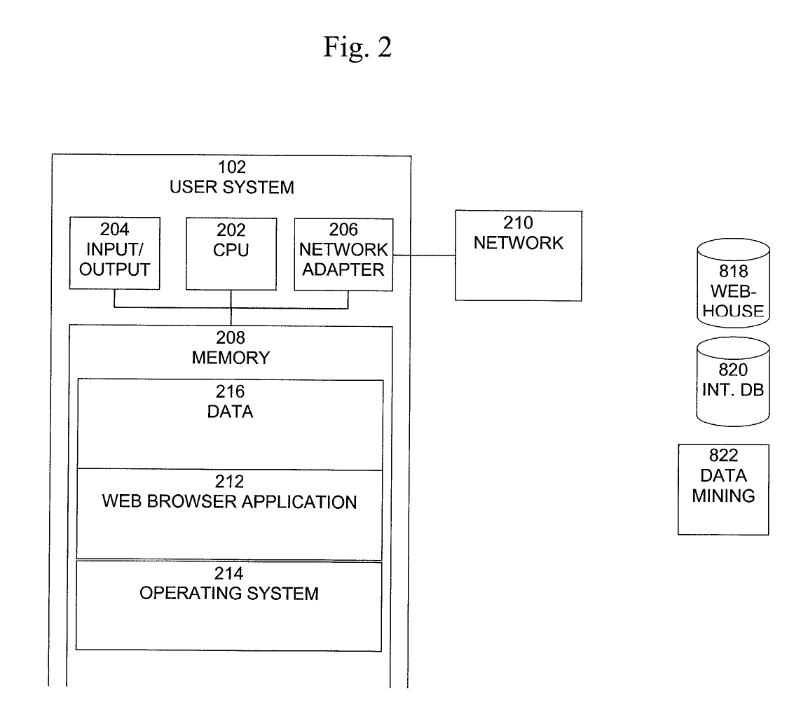

FIG. 2 is a block diagram illustration of user systems 102. The user systems 102 may include CPU 202, connected by a bus 408 or other suitable interface means to system memory 208. The user system 102 can also include input/output device interface, and display interface 204. Input/output device interface 204 enables interaction with and execution of instruction by user system 102 as directed by a user. Display interface can display information generated for output by user system 102 as provided by system 106.

As shown, the various components of the user system 102 communicate through a bus or similar architecture. Accordingly, systems memory 208 is disposed in communication with CPU 202 through bus. Systems memory 208 includes Browser Program 212, operating system 214 and data 216.

Operating system 214 provides overall system functionality. Browser Program 212 is computer program instructions executed by CPU 202. The browser program 3212 enables the information transmitted from system 106 to be conveyed to a user in a manner that can be understood by a user of user system 102. The browser 212 serves as a front end to the World Wide Web on the Internet.

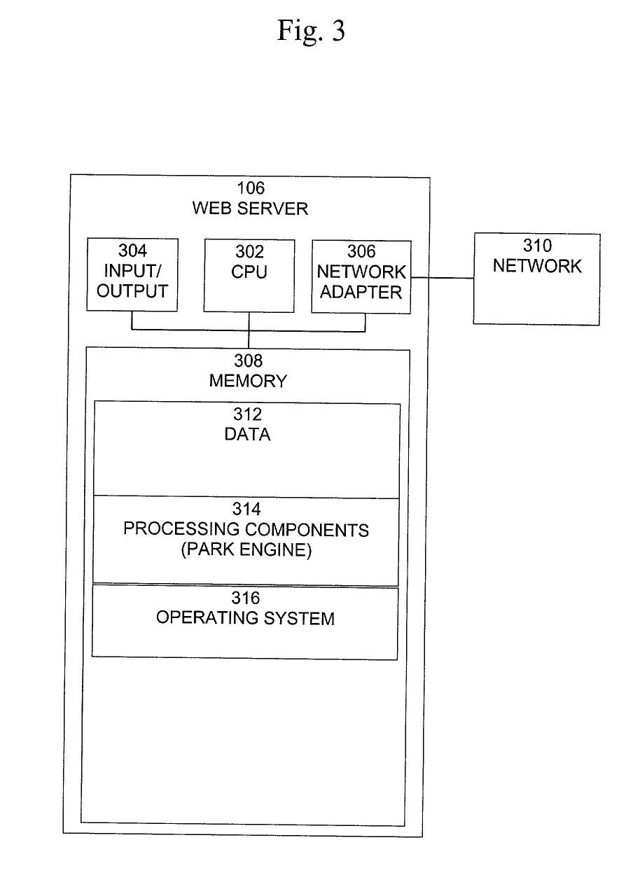

FIG. 3 is an exemplary block diagram of system 106 illustrated in FIG. 1, in which the present invention may be implemented. System 106 performs the function of developing/customizing web-based collaborative applications. The system 106 provides a scalable, secure, enterprise class software platform for web and email-based collaborative application. In the FIG. 3 embodiment, system 108 is a general purpose computer, such as a workstation, personal computer, server or the like, but may be any computer that executes program instruction in accordance with the present invention. System 106 includes a processor (CPU) 302 connected by a bus 318 to memory 308, network interface 310 and I/O circuitry 304.

In the FIG. 3 embodiment, CPU 302 is a microprocessor, such as an INTEL PENTIUM® or AMD® processor, but may be any processor that executes program instructions in order to carry out the functions of the present invention. As shown, CPU 302 and the various other components of the system 106 communicate through a system bus 318 or similar architecture. Network interface 310 provides an interface between system 106 and a network 104, such as the Internet. The network 104 may be a local area network (LAN), a wide area network (WAN), or combinations thereof. I/O circuitry 304 provides an interface for the input of structured information to and output of structured information from system 106. I/O circuitry 304 includes input devices, such as trackball, mice, touchpads and keyboards, and output devices, such as printers and monitors.

In the FIG. 3 embodiment, memory 308 stores application engine processing components 314, operating system 316 and data 312. Operating system 316 provides overall system functionality. Data 312 may be any structured data required by system 106, such as user data. This allows user data to be accessed and manipulated by the Form or other application components without accessing the database for every operation. The retrieval of the user data may be managed by a data access mechanism. The data access mechanism serves as the means for other application components to retrieve and store user data in the Form Instance. Through this mechanism, the user data can have all necessary operations validated and queued without database intervention.

Application engine components 314 provide the functionality associated providing a browser based wizard for developing and customizing collaborative web application executed by CPU 302. The application engine components may include a form engine, business rules engine, reports engine and email engine. The form engine manages the flow of data between the user and the system 108. The parts of the engine are generally divided into the input and output tracks, with the exception of the Database Interface, which handles data flow in both directions. The components of the form engine include a user input parser (Input Track), a metadata validator (Input Track), a business rule validator (Input Track), a business rule evaluator (Input Track), a database interface (Input/Output Tracks), a database interface (Input/Output Tracks) and an output template parser (Output Track).

The user input parser receives input from the user's client interface with the system 100 and converts any such input into data representations usable by the Form component and other data-accessing application components. The metadata validator ensures that any input from the user conforms to the restrictions placed on data cell, such as maximum length or number precision. The metadata validator will stop any information which does not meet these requirements from being entered into System 100. The business rule validator passes the user data through the administrator-defined specialized validation Business Rules to ensure that all data requirements are met before data is stored in the database. The business rule evaluator executes the remaining two kinds of administrator-defined business rules: calculation business rules which affect user data based on the input already received by the user and automated email business rules that send email to a pre-defined set of recipients and contain references to user data. The database interface stored the validated user data in the System 100 database for later retrieval. This portion of the form Engine is also responsible for retrieving user data from the database and storing it for use by the user or other application components. The Output Template Parser merges output templates with user-supplied data, allowing data records to be displayed to the user.

The Report engine generates a report object at runtime. It contains all report metadata necessary for execution, including display characteristics (based on consumer type) and the record set container. It includes a query builder to generates a SQL query based on existing metadata. The query is then added to the existing metadata definition. The Record Set Container with database access is contained within, and generated by, the Report object. It encapsulates all records in a result set returned from the database upon execution of the SQL query in metadata. The SQL query is modified beforehand, if necessary, to include runtime criteria conditions. Program instructions provide the functionality implemented by their respective routine. The program instructions may be recorded on a computer readable medium and loaded into memory 308.

The email engine includes the RichEmail Template Processor and the Distribution List Processor. The RichEmail builds APMessage objects based on metadata and form data. APMessage objects are used later to add a message to the email queue. RichEmail provides for output in HTML or plain text. Emails with multipart MIME types are also supported. The distribution lists are processed. Users are optionally presented with a list of recipients that can be filtered prior to the email being sent.

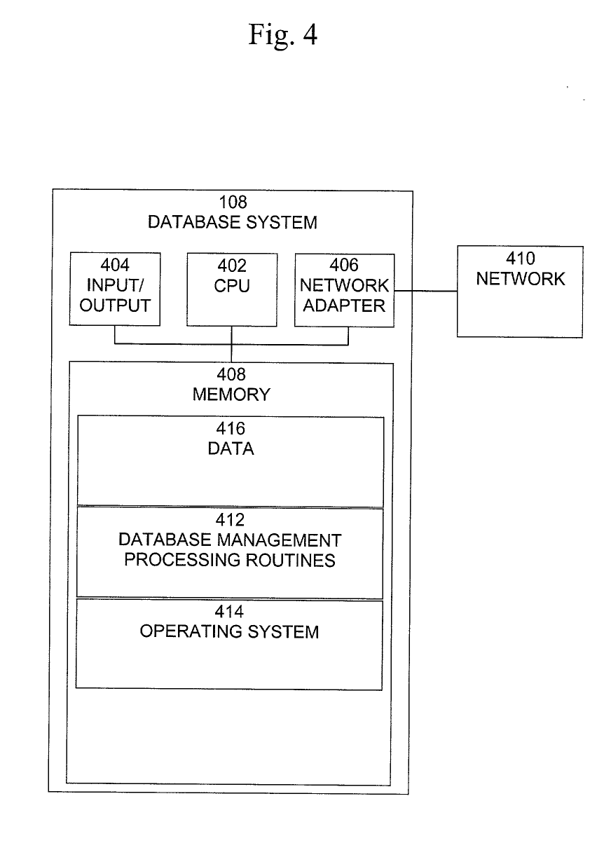

FIG. 4 is an exemplary block diagram of system 108 illustrated in FIG. 1, in which the present invention may be implemented. System 108 is a database management system, such as a relational database, that includes definitions of application component types as well as structure information managed by applications customized, developed and shared by users of network 104. In the FIG. 4 embodiment, system 108 is a general purpose computer, such as a workstation, personal computer, server or the like, but may be any computer that executes program instruction in accordance with the present invention. System 108 includes a processor (CPU) 402 connected by a bus 418 to memory 408, network interface 410 and I/O circuitry 404.

In the FIG. 4 embodiment, CPU 402 is a microprocessor, such as an INTEL PENTIUM® or AMD® processor, but may be any processor that executes program instructions in order to carry out the functions of the present invention. As shown, CPU 402 and the various other components of the server 108 communicate through a system bus 418 or similar architecture. Network interface 410 provides an interface between system 108 and a network 104, such as the Internet. The network 104 may be a local area network (LAN), a wide area network (WAN), or combinations thereof. I/O circuitry provides an interface for the input of structured information to and output of structured information from system 108. I/O circuitry 404 includes input devices, such as trackball, mice, touchpads and keyboards, and output devices, such as printers and monitors.

In the FIG. 4 embodiment, memory 408 stores data, such as metadata as well as structure information managed by applications customized and developed using system 100. Memory 408 includes routines, such as database management routines 412, and operating system 414. Memory 408 includes memory devices, such as read only memory (ROM), random access memory (RAM) hard disks, CD-ROMs, floppy disks, optical storage devices, magnetic storage devices, etc.

The structured information may be user data stored in response to input of data by users of applications whose component type definitions are stored in system 108. The metadata includes report metadata, form metadata and email metadata. The report metadata includes a SQL query, a consumer type, a display field, a criteria, a group bend and a chart. The stored SQL query is maintained as metadata but is generated by the Query Builder Engine based on the other report metadata, specifically the view relationships, displayed fields, and criteria. It is used to generate the record set. Criteria elements can be modified at runtime, allowing for a record set of varying size. Each report is based on a view within an application, from which data is included in the record set. The consumer type determines some differing behavior in execution. The displayed field (Column) metadata includes field type, view relationship and display characteristics. The criteria metadata includes field type, view relationship and a runtime/permanent criteria flag. If criteria is permanent, a data value is stored as metadata. Logical grouping information is also contained here. The group bend metadata is linked to displayed fields metadata. References to group band fields are actually references to displayed fields. Group boundary and second-level group boundary definitions are stored, along with aggregate type (sum, maximum, minimum, average, count). The chart Metadata is stored in conjunction with related Group Band Metadata. Metadata specific to charts.

Form metadata is made up of two major underlying structures. The first is an ApplForm, which serves as the metadata definition of a user's virtual database table. An ApplForm is made up of a collection of ApplForm Fields, with each one corresponding to a virtual data cell (or column). The other part of the Form Metadata is the View, which is similarly made up of View Fields. The View and view fields contain the data presentation information necessary for the use to interface with his or her virtual table. The definition of an ApplForm includes such information as the virtual table's unique name and system properties of the form. These properties label the form as a standard virtual table, a virtual table with system significance, such as a User Form, or a virtual table dependent on other virtual tables for data storage, such as a Repeating Row Table. The ApplForm Field definition includes information particular to an ApplForm Field, such as the type of data allowable in the field (text, numeric, date, etc.), default values, whether the field had certain system-significant properties, such as a record's primary key, and various validation properties of the field, such as whether an entry is required, or a maximum length. The View Definition includes information pertinent to the presentation of the virtual table to the user, wither for data entry, data editing, or use by other application components. This information is primarily comprised of the name of the View and its related ApplForm, also contains mechanisms to allow for alternate or more restricted views to the same virtual table. The View Field definitions include information regarding the presentation of virtual data cells to the user. This information consists of the type of control to be used for data entry or editing, the label associated with a field, whether the control can be used for editing data (read-only or read-write controls), the position of the field within the View, and any necessary layout properties, such as height and width.

Operating system 414 provides overall system functionality, such as management of routines in memory 412. Management routines 412 provide data management functionality.

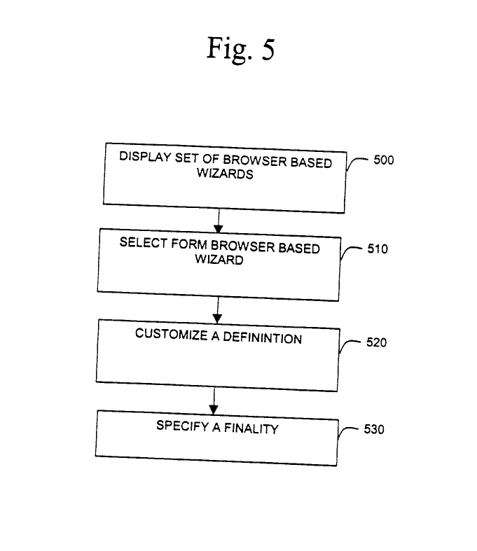

FIG. 5 is an exemplary flow diagram of a method of developing/customizing web-based collaborative applications, which may be implemented by the present invention. In the FIG. 5, embodiment, the process begins with step 500, in which a browser-based form wizard is displayed. The form wizard is one wizard of multiple wizards available to the user. For example, there may be a report browser based wizard, an email browser based wizard, a business rules browser based wizard, and a calendar browser based wizard. The form wizard provides the capability to create new Forms or customize existing Forms. A form the containers and managers of system 100 user data Forms serve as a means for users to enter and edit their data in system 100 as well as a transport to bring user data to various other application components.

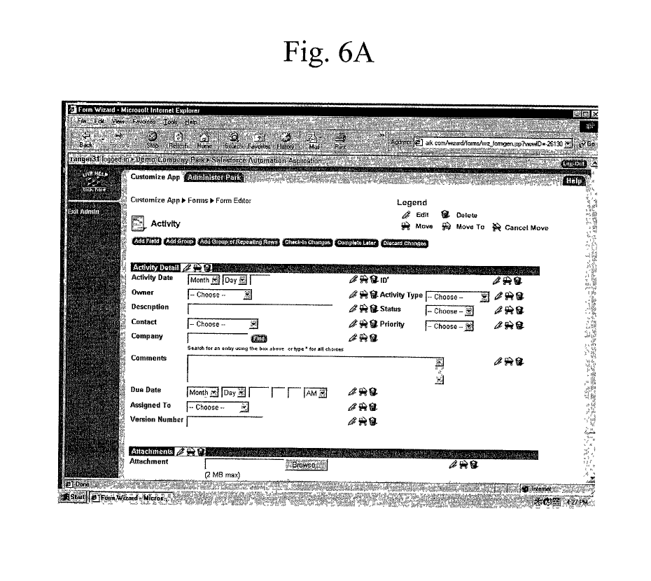

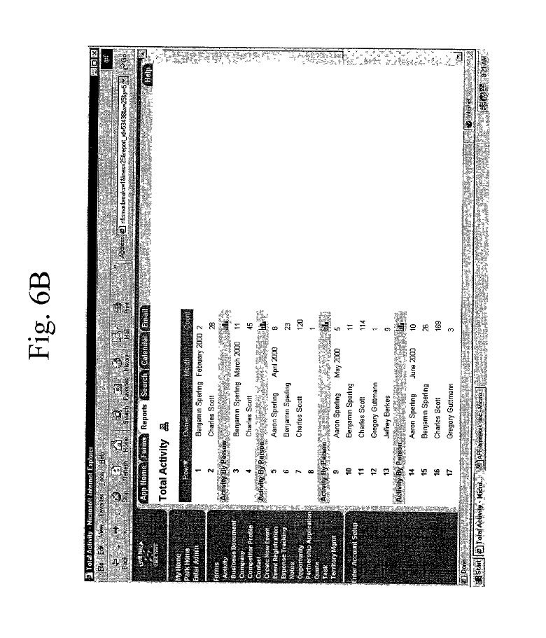

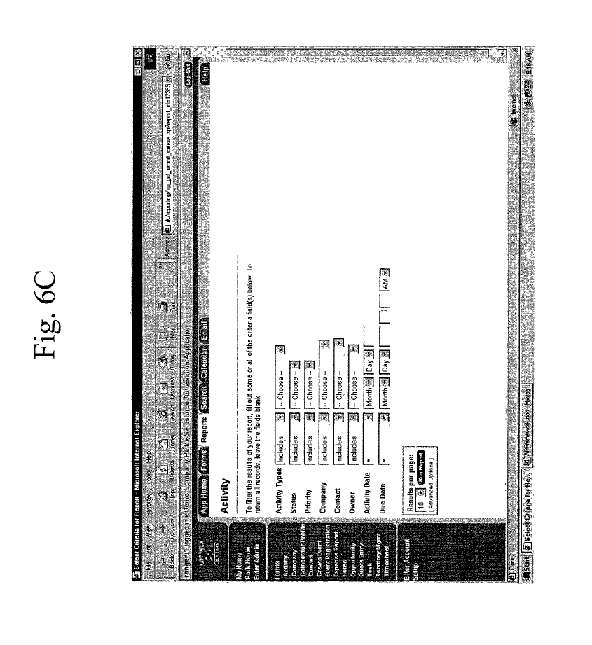

Tuning now briefly to FIG. 6A. In the embodiment of FIG. 6, an exemplary embodiment of a browser-based form wizard is illustrated. As with each application component, a Form has a set of properties and behaviors that are defined at design-time through the Form Wizard. The definition of each Form is maintained in the database. The form wizard includes the following types of sub-components: groups, groups with repeating rows, and fields.

Group provides a visual container for fields. A Group is not an input control. It contains a Label property to identify itself. Field provides an input and display control on a Form. A Field has a number of properties that define its domain such as the type of data that can be entered. Data entered into a Field will get stored in the database upon a Save operation that passes all the validation tests. There are two levels of validation tests. First, the Form processor validates the data entered into each control for the appropriate data type. Second, the Form processor invokes all business rules that also provide supplementary validation rules. Group with repeating rows provides a container for defining a set of Fields (Row) that can be repeated as many times as needed. The Administrator can override the default number of times the Row will repeat. A User can add more Rows as needed. This capability is useful when you want to create a Header-Detail relationship on a Form, i.e. have a Form that has Order Header information as well as One-to-Many Order Detail rows. Additional components, less visible, include a view definition. The view definition is a component that underlies a Form definition. In the process of defining a Form, an associated View is created. This View is called the Default View. The APFramework is being extended to support other Views of the same Form. Note: When relationships are created between Forms by defining a Field that pulls data from the set of records associated with another Form, an Extended View is created. Other application components are defined based not on the Default View, but the Extended View.

Returning now to FIG. 5. In step 510, a user selects a browser-based form wizard. The browser-based wizard may be selected to customize an existing form or create a new form. The browser-based wizard can be accessed, for example, by selecting a tab representing the form wizard. In Step 520, a definition for the form can be customized. Customization of a definition for a form is reflected in a display are of the form wizard. The portion of the definition that can be modified includes the properties portion and the behavior portion. The definition is customizable by selection of a sub-component types on the form wizard operable to customize a definition. In step 530, the finality of the customization can be specified. The customization or development may be

Tuning now briefly to FIG. 6B. In the embodiment of FIG. 6B, an exemplary embodiment of a browser-based report wizard is illustrated. Searching and Reporting is an important capability for any business application. The APFramework Engine provides a point-and-click Wizard to define Reports and Searches. The primary difference between Reports and Searches is that Reports support grouping of data. An example of this is a report that presents Total Sales by Month.

Through the Administration Menu, Administrators can create new or edit existing Reports. Report creation is supported through the Report Wizard. The Wizard is a 5-step process in which not all the steps are required. Specification of Report Name and View to use for the Report. This is a required step. Specification of the Fields to display in the Report. This is a required step. Customization of Report Field Labels, Sort Order, Grouping, and Column Order. This is an optional step. Specification of Group Bands. This is an optional step. This step is not available in Searches. Specification of Report Criteria. This Criteria typically filters the data returned within this report. The Report Criteria may be configured to pre-select the entire set of criteria or can be set up to allow the User to specify the criteria at run-time. Specification of Graphs. Bar and pie charts can be configured to display report results. This is an optional step. This step is not available in Searches.

FIG. 6C depicts a report form according to an embodiment of the present invention. Report execution occurs through the application interface. The first step of execution is selection of values that will filter the reported results. In this same screen, the User can specify the number of reporting results rows to view on each page. Below is a screen print of the Criteria Selection Form.

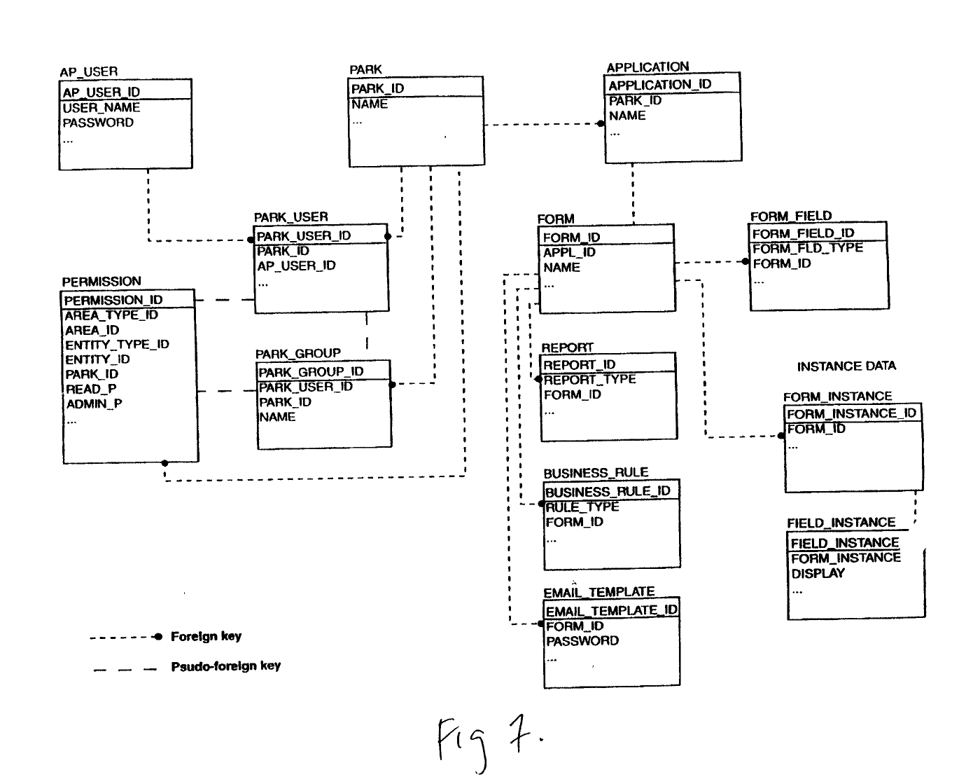

FIG. 7 depicts a database schema according to embodiments of the present invention. The Meta-database Schema is composed of over 100 separate tables. The tables in our meta-database include Static System Tables to store system 100 constants, data and control types, etc, dynamic system tables to store user info and user tables to Store Park-level information and below (parks, applications, forms, etc.)

These tables are structured in a relational database. The database is normalized, but some redundant key information is stored in certain tables in order to optimize application-or park-level queries. Starting with the Application record, loop through all components and sub-components, creating records that are identical except for identity columns. Temporary mapping tables are used to map ID numbers from components of the original application to those in the target application. Cached items are automatically regenerated in the target application.

A list of hierarchical view of how Copy App works, with cursors used to loop through each type of component (below application) based on a parent-key value may be as follows:

1. The Application record is copied.

2. Form records within the application are copied.

3. Field records within each form are copied.

4. Field value records for each field are copied.

5. View records within each application are copied.

6. Group records within each view are copied.

7. Field records within each view are copied.

8. Field-to-form association records within the application are copied.

9. Display component records for each field-to-form association are copied.

10. All other component records within the application (and their sub-components) are copied.

Dependency Checking

Before an application, form, or field may be deleted, we run a union-query against the meta-database to determine whether any separate components are dependent on the metadata definition of that application, form, or field. These checks help prevent metadata inconsistencies.

Form Check-in/Check-out

Two copies of the metadata for each Form are maintained. One is used for execution, one is used for administration. The ID numbers in the copy used for administration are equivalent to the ID numbers in the execution copy multiplied by −1. The records in the administrative copy may be edited without affecting the execution copy. After a set of changes has been made to the administrative copy, those changes can be “checked-in,” meaning the administrative copy overwrites the execute copy, or the changes may be “discarded,” meaning that the executive copy overwrites the administrative copy. Discrepancies between the two form copies are found by comparing the timestamp values of each set of records and reconciled by adding, deleting, or altering records accordingly. The records are compared in the following order:

1. Form

2. Fields

3. FieldValues

4. Field-to-form associations

5. Field-to-form association display components

6. Views

7. Groups

8. Fields

Virtual-Database Functionality

Our Virtual-Database includes two types of tables System Data Tables: Store data which can be shared among all applications in the Application Park Framework Engine (such as languages, countries, and time zones).Virtual Data Tables: Store all users' data. The System Data Tables are stored as normalized data. The Virtual Data Tables are stored as non-normalized key-value pairs. Individual records of data are stored as Form Instances and contain information identifying parent forms, update statistics, and other record-wide information. “Cells” of data are stored as Form Field Instances and relate a record and a parent field to one piece of data. This piece of data can be a raw chunk of information (such as an arbitrary piece of text, number, or date) or a key relating the Form Field Instance to another data record (such as a System Data Item, a member of a user-defined set of data, or even another virtual record).

The present invention is described hereinabove with reference to flowchart illustrations of methods, apparatus (systems), methods of doing business and computer program products according to the invention. It will be understood that each block of the flowchart illustrations, and combinations of blocks in the flowchart illustrations, can be implemented by computer program instructions. These computer program instructions may be loaded onto a general-purpose computer, special purpose computer, or other programmable data processing apparatus to produce a machine. These computer program instructions, which execute on the computer or other programmable data processing apparatus, create means for implementing the functions specified in the flowchart block or blocks. These computer program instructions may be stored in a computer-readable memory to direct a computer or other programmable data processing apparatus to function in a particular manner, producing an article of manufacture including instruction means which implement the function specified in the flowchart block or blocks. The computer program instructions may also be loaded onto a computer or other programmable data processing apparatus to cause a series of operational steps to be performed, producing a computer implemented process, such that the computer or other programmable apparatus provide steps for implementing the functions specified in the flowchart block or blocks.

While specific embodiments of the present invention have been illustrated and described, it will be understood by those having ordinary skill in the art that changes may be made to those embodiments without departing from the spirit and scope of the invention.

What is claimed is:

1. A system for developing/customizing web-based collaborative applications employing visual-based programming, comprising:
a user system operable to display a set of browser-based component wizards to develop application component types for a web-based collaborative application;
a network, coupled to a set of processing components and the user system, operable to communicate data; and
the set of processing components, each processing component in the set for implementing functionality associated with a definition for each of the application component types, wherein the functionality exists prior to customization of the definition for each of the application component types.

2. The system according to claim 1, wherein the set of browser-based wizards includes a combination of: a form wizard, a business rule wizard, a report wizard, a search wizard, a calendar wizard and an email wizard.

3. The system according to claim 2, wherein each browser-based wizard is operable to customize a definition for a corresponding application component type.

4. The system according to claim 3, wherein each browser-based wizard in the set of browser-based wizards has a set of sub-component types, the set of sub-components types in a browser-based wizard configured to dynamically perform the customization of the definition for the corresponding application component type.

5. The system according to claim 4, wherein at least some of the sub-component types in the set of sub-component types in the browser-based wizard are operable to dynamically generate a default visual representation of the customization of the definition in a display area of the browser-based wizard.

6. The system according to claim 5, wherein the generation of the visual representation associates a default property definition to a properties-based portion of the definition for the corresponding application component type.

7. The system according to claim 4, wherein at least one of the sub-components types in the set of sub-component types in the browser-based wizard is operable to dynamically modify a properties-based portion of the definition with a customized property definition for the corresponding application component type.

8. The system according to claim 7, wherein the customized property definition for the corresponding application component type is dynamically applied by providing visual representations in a display area of the browser-based wizard according to the customized property definition.

9. The system according to claim 8, wherein a physical property of the corresponding application component type modified by the customized property definition includes one of: orientation, position, labeling, and design.

10. The system according to claim 4, wherein at least one of the sub-components types in the set of sub-component types in the browser-based wizard is operable to dynamically modify a behavior-based portion of the definition with a customized behavior definition for the corresponding application component type.

11. The system according to claim 10, wherein the customized behavior definition for the corresponding application component type is dynamically applied in accordance with the customized behavior definition to visual representations provided in a display area of the browser-based wizard.

12. The system according to claim 11, wherein a behavioral property of the corresponding application component type modified by the customized behavior definition includes one of; data input type, data input length, data requirements, data modification terms and data retrieval terms.

13. The system according to claim 4, wherein at least some of the sub-component types in the set of sub-component types in the browser-based wizard are operable to specify the finality of the customization of the definition for the corresponding application component.

14. The system according to claim 13, wherein the finality specifiable includes any combination of: discard customizations, implement customizations and delay customizations.

15. A method of developing/customizing web-based collaborative applications employing visual-based programming, comprising:
displaying a set of browser-based component wizards to develop application component types for a web-based collaborative application; and
implementing functionality associated with a definition for each of the application component types, wherein the functionality exists prior to customization of the definition for each of the application component types.
